(19) United States
(12) Patent Application Publication
(10) Pub. No.: US 2026/0114482 A1
(43) Pub. Date: Apr. 30, 2026

(54) WHOLE-EGG-BASED LIQUID FOODS AND METHODS OF PREPARING WHOLE-EGG-BASED LIQUID FOODS

(71) Applicant: HBF Sustainable Food Lab LLC, Morristown, TN (US)

(72) Inventors: Daniel Felder, Berkeley, CA (US); Jonathan Ali Bouzari, Los Angeles, CA (US)

(73) Assignee: HBF Sustainable Food Lab LLC, Morristown, TN (US)

(21) Appl. No.: 19/374,797

(22) Filed: Oct. 30, 2025

Related U.S. Application Data
(60) Provisional application No. 63/714,318, filed on Oct. 31, 2024.

(51) Int. Cl. A23L 15/00; A23L 2/38; A23L 2/56; A23L 2/68; A23L 27/10; A23L 27/40; A23L 27/60; A23L 29/238; A23L 33/115; A23L 33/135

(52) U.S. Cl. CPC A23L 15/30; A23L 2/38; A23L 2/56; A23L 2/68; A23L 15/25; A23L 27/10; A23L 27/40; A23L 27/60; A23L 29/238; A23L 33/115; A23L 33/135

(57) ABSTRACT

Non-dairy egg-based liquid food products are provided, comprising: liquified hard-cooked egg including cooked egg yolk and cooked egg white, a predetermined amount of liquid having a moisture content of at least about 65% by weight, one or more flavoring ingredients; an acidifier; a thickening agent; and a predetermined amount a food additive for mitigating an impact of sulfurous compounds on taste; and the non-dairy egg-based liquid food product has a pH between about 3.9 to about 4.4, the predetermined amounts of the hard-cooked egg and the liquid is at least about 33% and 15% by weight of the food product, respectively, and the predetermined amount of oil is less than about 0.01% by weight of the food product.

### FIELD

The present disclosure generally relates to whole-egg-based foods, and methods of preparing whole-egg-based foods. More particularly, the present disclosure generally relates to whole-egg-based liquid foods prepared from hard-cooked eggs, and methods of preparing whole-egg-based liquid foods from hard-cooked eggs.

### SUMMARY

In accordance with some embodiments of the disclosed subject matter, a non-dairy hard cooked egg-based liquid food product is provided, comprising: a predetermined amount of liquified hard-cooked egg, the hard-cooked egg including cooked egg yolk and cooked egg white, wherein the predetermined amount of hard-cooked egg is at least about 33% by weight of the non-dairy egg-based liquid food product; a predetermined amount of liquid having a moisture content of at least about 65% by weight, wherein the predetermined amount of liquid is at least about 15% by weight of the non-dairy egg-based liquid food product; one or more flavoring ingredients; an acidifier; a thickening agent; and a predetermined amount of a food additive for mitigating an impact of sulfurous compounds on a taste of the non-dairy egg-based liquid food product, wherein the predetermined amount of the food additive is less than 0.01% by weight of the non-dairy egg-based liquid food product; and wherein the non-dairy egg-based liquid food product has a pH between about 3.9 to about 4.4.

In some embodiments, the non-dairy egg-based liquid food product is a semisolid non-dairy yogurt, a non-dairy drink, a dip, or a salad dressing.

In some embodiments, the non-dairy egg-based liquid food product is the semisolid non-dairy yogurt, wherein the flavoring ingredients comprise vanilla extract, wherein the predetermined amount of liquid comprises: coconut cream; water; banana puree; and lemon juice, and wherein the non-dairy egg-based liquid food product comprises a spore-form probiotic.

In some embodiments, the non-dairy egg-based liquid food product is the non-dairy drink, wherein the flavoring ingredients comprise vanilla extract and vanilla powder, and wherein the predetermined amount of liquid comprises: coconut cream; water; banana puree; and lemon juice.

In some embodiments, the non-dairy egg-based liquid food product is the dip, wherein the flavoring ingredients comprise roasted red pepper, mango, sea salt, and spices, and wherein the predetermined amount of liquid comprises: water; sweet potato puree; and lime juice.

In some embodiments, the non-dairy egg-based liquid food product is the salad dressing, wherein the flavoring ingredients comprise spices, and wherein the predetermined amount of liquid comprises: water; and lemon juice.

In some embodiments, a ratio of cooked egg yolk to cooked egg white is about 2:1 by weight.

In some embodiments, the predetermined amount of hard-cooked egg is at least about 50% by weight of the non-dairy egg-based liquid food product.

In some embodiments, the predetermined amount of liquid comprises water that is at least about 15% by weight of the non-dairy egg-based liquid food product.

In some embodiments, the predetermined amount of the food additive includes an oil comprising citral,

In some embodiments, the oil comprising citral includes lemon oil with a citral content of about 2% to about 5% by weight of the lemon oil.

In some embodiments, the thickening agent comprises guar gum.

In some embodiments, the acidifier comprises lemon juice or lime juice.

In some embodiments, the non-dairy egg-based liquid food product does not include any purified fat ingredients in an amount greater than 0.01% by.

In some embodiments, the non-dairy egg-based liquid food product does not include any of the following ingredients in an amount greater than 0.01% by weight of the non-dairy egg-based liquid food product: olive oil; canola oil; and mayonnaise.

In some embodiments, the non-dairy egg-based liquid food product is at least 6% protein by weight.

In accordance with some embodiments of the disclosed subject matter, a method of making a non-dairy egg-based liquid food product is provided, the method comprising: mixing a predetermined amount of hard-cooked egg, a predetermined amount of liquid having a moisture content of at least about 65% by weight, one or more flavoring ingredients, an acidifier, and a predetermined amount of a food additive for mitigating an impact of sulfurous compounds on a taste of the non-dairy egg-based liquid food product, thereby forming a preliminary blend comprising the predetermined amount of hard-cooked egg, the predetermined amount of liquid, the one or more flavoring ingredients, the acidifier, and the predetermined amount of the food additive; mixing a thickening agent into the preliminary blend, thereby forming an intermediate blend from the preliminary blend and the thickening agent; homogenizing the intermediate blend, thereby forming a primary blend from the intermediate blend, wherein the primary blend has a pH between about 3.9 to about 4.4; adding the non-dairy egg-based liquid food comprising the primary blend to a plurality of containers; sealing the plurality of containers; pasteurizing the non-dairy egg-based liquid food in the plurality of sealed containers, wherein the internal temperature of the non-dairy egg-based liquid food reaches a safety threshold temperature during pasteurization; and cooling the non-dairy egg-based liquid food after pasteurization.

In some embodiments, the safety threshold temperature is about 165° Fahrenheit.

In some embodiments, pasteurizing the non-dairy egg-based liquid food in the plurality of sealed containers comprises: applying high pressure to the plurality of sealed containers to mitigate risks caused by food-borne pathogens.

### BRIEF DESCRIPTION OF THE DRAWINGS

The present disclosure is described with reference to the following drawings.

FIG. 1 shows an example of a process for preparing whole hard-cooked-egg-based foods with variable viscosities in accordance with some embodiments of the disclosed subject matter.

FIG. 2 shows examples of whole hard-cooked-egg-based foods with variable viscosities in accordance with some embodiments of the disclosed subject matter.

### DETAILED DESCRIPTION

There is a market for hard cooked eggs, which are often sold packaged as snacks, or ingredients, and are often sold whole and peeled. Some portion of eggs that are processed for sale as hard cooked eggs are damaged, and are not suitable for sale as whole hard-cooked eggs. For example, some portion of the eggs do not peel cleanly, with a portion of the cooked white being stuck to, and removed with, the shell during peeling. While many egg-based products exist, such as custard-based foods and mayonnaise, such products typically start with uncooked egg, often only use the egg yolk, and often involve adding a significant amount of additional purified fat (e.g., oil, butter, etc.). There are not many high value uses for these damaged eggs, especially as products that are produced in large quantities that are distributed to retailers. For example, damaged hard cooked eggs can be used to produce egg salad. However, egg salad generally has a relatively short shelf life, even when refrigerated, and much egg salad sold at retailers is made locally (e.g., in a deli department of a grocery store). Additionally, the usable shelf-life of the damaged hard-cooked eggs is significantly shorter than the whole undamaged eggs making their use problematic.

In some embodiments, products and processes described herein can include use of whole hard-cooked eggs as a primary ingredient in foods that are traditionally based on dairy and/or purified fats. Many foods marketed as high protein foods have an unpleasant taste. However, liquified hard cooked eggs prepared as described herein have a mild taste that can serve as a base for other flavors, such as sweet flavors (e.g., vanilla, fruit, etc.) and/or savory flavors (e.g., vegetable flavors, herbal flavors, etc.).

As described below, hard cooked egg can be combined with other ingredients to produce high-protein, dairy-free versions of products with various densities, viscosities, and/or textures. For example, as described below, in some embodiments, techniques described herein can be used to produce high-protein non-dairy versions of creamy semi-solid foods (e.g., yogurt) using liquified hard cooked eggs as a primary ingredient. As another example, techniques described herein can be used to produce high-protein non-dairy drinks (e.g., fruit smoothies) using liquified hard cooked eggs as a primary ingredient. As yet another example, techniques described herein can be used to produce high-protein dips (e.g., dips that are often eaten with raw vegetables, pretzels and other savory snacks, etc.) using liquified hard cooked eggs as a primary ingredient. As still another example, techniques described herein can be used to produce high-protein condiments (e.g., creamy salad dressings) using liquified hard cooked eggs as a primary ingredient.

As described below, in some embodiments, hard cooked eggs can be combined with (e.g., via a mixer) sweet and/or savory ingredients, one or more flavorings (e.g., concentrated natural flavorings), and an acidifier(s). A thickener can be added after combining the other ingredients, and when sufficiently mixed can be further processed to homogenize the resulting mixture with a relatively small particle size (e.g., via a milling device). Additional ingredients can be included, such as probiotics, or food additives (e.g., a food additive, such as lemon oil, that can mitigate an impact of sulfurous compounds that can be introduced by the hard cooked egg on a taste of the final product).

As used herein, “about” and “approximately” will be understood by persons of ordinary skill in the art and will vary to some extent based on the context in which they are used. If there are uses of the term which are not clear to persons of ordinary skill in the art given the context in which it is used, “about” and “approximately” will mean plus or minus ≤10% of the particular term.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

The percentages disclosed herein are generally provided on a “weight/weight” or “(w/w)” basis. The % (w/w) of a component in a composition disclosed herein is determined by dividing the weight of the component added to the composition (e.g., as measured in grams) by a total weight of the final composition. For example, if the weight of a component (“component A”) added to a composition is 51 grams and the final weight of the composition is 100 grams, the % (w/w) of component A in the composition is 51% (w/w). Example non-limiting components and associated percentage ranges that may be used to make egg-based liquid foods disclosed herein are described below (e.g., in the Examples). Some suitable substitutes for these components are also described herein, although others may be readily apparent to those of skill in the art.

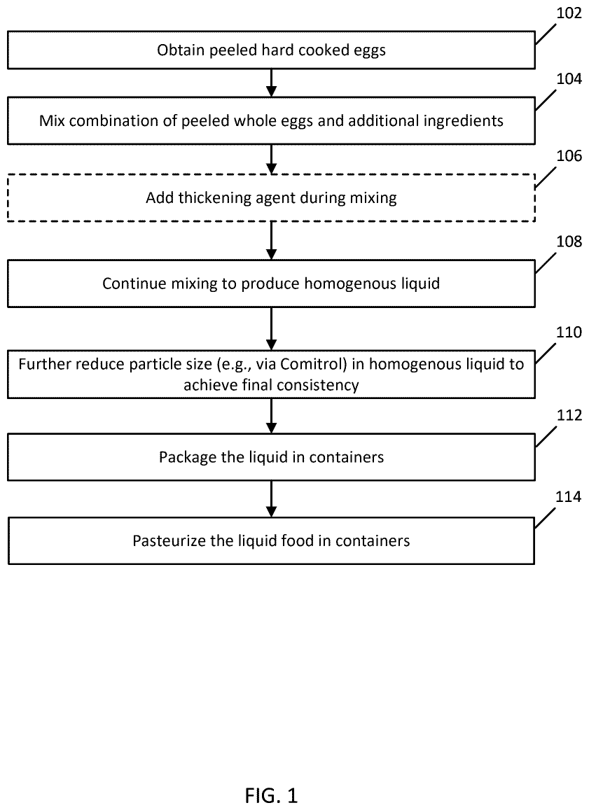

FIG. 1 shows an example of a process 100 for preparing whole-egg-based liquid foods in accordance with some embodiments of the disclosed subject matter.

As shown in FIG. 1, process 100 can include, at 102, obtaining whole peeled hard cooked eggs. In some embodiments, peeled hard cooked eggs can be obtained from any suitable source and/or using any suitable preparation technique(s). In some embodiments, as used herein, a hard cooked egg can be an egg heated to at least a temperature at which both the yolk and white have solidified.

In some embodiments, whole hard cooked eggs can be obtained from a processor that hard cooked and peeled the eggs. Additionally or alternatively, in some embodiments, whole hard cooked eggs can be prepared by a processor that is preparing whole-egg-based liquid foods described herein.

In some embodiments, the peeled hard cooked eggs obtained at 102 can be hard cooked using any suitable technique(s). For example, hard cooked eggs can be obtained by boiling eggs in water until the white and yolk have both solidified. As another example, hard cooked eggs can be obtained by steaming eggs until the white and yolk have both solidified. As yet another example, hard cooked eggs can be obtained by baking eggs until the white and yolk have both solidified.

At 104, process 100 can include mixing the peeled hard cooked egg and other ingredients of the food product that is being prepared. For example, the peeled hard cooked egg can be combined with ingredients used for flavoring and/or to achieve a particular consistency (e.g., characterized by viscosity). As described below in connection with 106, in some embodiments, a thickening agent can be added after combining other ingredients with the peeled hard cooked eggs, such that thickening caused by the thickening agent does not begin to occur until after the other ingredients are combined and relatively homogenous.

In some embodiments, one or more of the ingredients can be partially processed prior to combining at 104. For example, whole eggs obtained at 102 can be chopped (e.g., using a course chopper) prior to combining with other ingredients. As another example, other ingredients, such as whole fruits and/or vegetables, can be chopped, pureed, etc., prior to combining with other ingredients.

In some embodiments, at 104, process 100 can include mixing the hard-cooked egg (e.g., including hard cooked yolk and hard cooked egg white) with other ingredients, such as a liquid(s), an acidifier(s), fruit and/or vegetable-based ingredients, a sweetener and/or flavoring, a probiotic, and/or any other suitable ingredients. The combination of the hard-cooked egg and other ingredients, prior to adding a thickener, is sometimes referred to herein as a preliminary blend. For example, the hard-cooked egg can be combined with water, which can impact a consistency of the food being prepared using process 100. As another example, the hard-cooked egg can be combined with lactic acid, which can impact a final pH of the food being prepared using process 100. Note that an acidifier may impact flavor of the food, and other ingredients (e.g., citrus juice, such as lemon juice) may impact the pH of the food. As yet another example, fruit and/or vegetable ingredients can include ingredients that impact the consistency, mouth feel, and/or flavor of the food being prepared using process 100, such as coconut cream, banana puree, water, roasted vegetables (e.g., roasted red peppers), mango, sweet potato puree, etc. As still another example, sweetener and/or flavoring ingredients can include ingredients such as vanilla extract, cane sugar, lemon juice, lactic acid, vanilla powder, salt (e.g., sea salt), spices, yeast extract, etc. As a further example, a probiotic that is capable of surviving process 100 can be added, such as a probiotic that is in a spore form that is resistant to thermal damage and/or damage from other destructive processes, and which can reproduce in the human gut after consumption in food. As a particular example, spore-form Bacillus coagulans GBI-30, 6086 (also known as BC30) can be added as a probiotic. As another further example, a food additive that mitigates unpleasant odors and/or tastes that may be introduced by the hard-cooked egg can be added, such as a food additive that includes one or more compounds that mitigate an unpleasant taste and/or smell caused by caused sulfurous compounds introduced by the hard-cooked egg. As a particular example, lemon oil and/or lime oil can include one or more components that can mitigate a sulfurous taste and/or smell that can be introduced by hard cooked eggs, and can be included in a very small amount at 104 to reduce or eliminate a sulfurous taste and/or smell in final product. As a more particular example, citral is an acyclic monoterpene aldehyde that is present in lemon oil and lime oil, and is believed to be a component of lemon oil or lime oil that can mitigate a sulfurous taste and/or smell. Note that other natural sources of citral are available, in addition to, or in lieu of, lemon oil or lime oil, such as lemongrass oil, and lemon balm oil, which may be suitable for use as a food additive (e.g., in addition to, or in lieu of lemon oil and/or lime oil). As described below in connection with Examples 1 to 4, liquid food products that included lemon oil did not have strong sulfurous tastes and/or smells.

In some embodiments, any suitable mixing process(es) and/or device(s) can be used to prepare the preliminary blend, which can be a relatively homogenous mixture of the ingredients included in the preliminary blend. For example, “mixing” can refer to a process of combining ingredients together to create a relatively homogenous mixture of the ingredients, which can be accomplished by any suitable means known in the art including, without limitation, hand-mixing, and/or use of mixer such a propeller-type mixer, a blender, a grinder, etc., which can include use of commercial scale versions of such devices. In some embodiments, the whole egg and other ingredients can be mixed for any suitable length of time, and/or until any suitable criterion or criteria is achieved. For example, the whole egg and other ingredients can be mixed to achieve a relatively uniform distribution of the ingredients. As another example, the whole egg and other ingredients can be mixed until the preliminary blend has liquified.

In some embodiments, whole-egg-based foods prepared using techniques described herein (e.g., using process 100) can have a similar texture and mouthfeel to foods that are conventionally based on dairy and/or purified fat, such as yogurt, smoothies, dips, and dressings. For example, as described below in connection with Examples 1 and 2, whole-egg-based foods prepared using techniques described herein be used to prepare non-dairy yogurt and non-dairy smoothies that do not include any dairy-based ingredients, such as milk. As another example, as described below in connection with Examples 3 and 4, whole-egg-based foods prepared using techniques described herein can be used to prepare dips and/or dressings that do not include any dairy-based ingredients (e.g. sour cream, buttermilk, etc.), and that do not include any purified fats (e.g., olive oil, canola oil, soybean oil, vegetable oil, mayonnaise, cream cheese, etc.). As yet another example, whole-egg-based foods prepared using techniques described herein can be used to prepare versions of dips and/or dressings (e.g., higher protein version, nut-free versions, etc.) that use other ingredients as a base ingredient, such as dips and/or dressing that use chickpeas, nuts, seeds, avocado, etc.

In some embodiments, the relative proportions of hard cooked egg and other ingredients can vary depending on the desired properties of the product that is being produced. Regardless, the hard cooked egg can be a primary or main ingredient of the product that is being produced. For example, hard cooked egg can be the predominant ingredient by weight in the finished product (e.g., on a % (w/w) basis). In some embodiments, the hard cooked egg can impact the final texture and/or thickness of the product that is being produced. In some embodiments, the proportion of hard cooked egg in the final product can be at least 33% by weight of the packaged product, and can be over 50% by weight of the packaged product. For example, hard cooked egg can be in a range of about 33% to about 60% by weight of the packaged product. As another example, hard cooked egg can be in a range of about 40% to about 55% by weight of the packaged product.

In some embodiments, the cooked egg yolk (and potentially other ingredients, such as banana puree) can contribute to a yellow color to the preliminary blend. In a product that consumers expect to be a white color, such as plain or vanilla yogurt, one or more ingredients that mitigate the yellow coloring of the egg yolk (and/or other ingredients) can be included, such as coconut cream, which can lighten the color of the preliminary blend (and final product). In some embodiments, food additives that are often used to whiten foods (e.g., titanium dioxide) can be excluded from the egg-based product being prepared using process 100.

At 106, process 100 can include adding a thickening agent during mixing of the other ingredients. In some embodiments, for example, a thickening agent can be added to the preliminary blend to achieve a particular consistency (e.g., characterized by viscosity) and/or texture. In some embodiments, any suitable thickening agent can be used to thicken a whole-egg-based food being prepared using process 100, such as guar gum, agar agar, psyllium, xanthan gum, etc.

In some embodiments, process 100 can include adding the thickening agent to the preliminary blend in the device or vessel in which the preliminary blend is mixed at 104. Alternatively, process 100 can include adding the thickening agent to the preliminary blend after transferring the preliminary blend from the device or vessel in which the preliminary blend is mixed at 104. The combination of the preliminary blend and the thickening is sometimes referred to herein as an intermediate blend.

In some embodiments, any suitable mixing process(es) and/or device(s) can be used to prepare the intermediate blend, which can be a relatively homogenous mixture of the ingredients included in the preliminary blend with the thickening agent, such as mixing process(es) and/or device(s) described above in connection with 104, including commercial scale mixing processes and/or devices.

In some embodiments, process 100 can omit adding a thickening agent at 106. For example, one or more ingredients added at 104 may act as a thickening agent. As another example, mixing the combination of ingredients added at 104 may result in the resulting liquid having a sufficient thickness (e.g., after 104 and/or 108, described below).

Additionally, in some embodiments, at 108, process 100 can include continuing to mix the intermediate blend until the thickening agent is relatively uniformly distributed within the intermediate blend (e.g., until the intermediate blend becomes a macroscopically and/or microscopically homogenous liquid). In some embodiments, the whole egg and other ingredients can be mixed for any suitable length of time (e.g., about five minutes), and/or until any suitable criterion or criteria is achieved.

At 110, process 100 can include further reduction of the particle size of the intermediate blend and/or further homogenization of the intermediate blend to achieve a final consistency for the product. For example, the intermediate blend can be passed through a liquid-finishing device with an appropriately sized tool or combination of tools (e.g., a cutting head with appropriately spaced blades, a plate with appropriately sized holes, etc.), such as a COMITROL processor (available from Urschel Laboratories Inc., headquartered in Chesterton, Indiana, USA), to produce a liquid that is ready for further processing, such as packaging. In a more particular example, a COMITROL Processor Model 1500 with a microcut head can be used to further reduce and/or homogenize a particular size of the intermediate blend to produce a liquid that is ready for further processing, such as packaging. In some embodiments, a type and/or configuration of a device used to further reduce particle size can be based on a desired particle size and/or texture of the whole-egg-based product being prepared. The liquid produced at 110 is sometimes referred to herein as a primary blend. In some embodiments, at 110, the particle size can be reduced below a size below a size at which a person can distinguish individual particles (e.g., below a size at which a person may consider the primary blend to be gritty).

In some embodiments, processing (e.g., mixing, particle size reduction, etc.) at 104, 106, 108, and/or 110 can be characterized as emulsifying, regardless of whether the resulting blend is an emulsion in a technical sense. For example, if two or more of the ingredients added at 104 and/or 106 are normally immiscible, processing at 104, 106, 108, and/or 110 can be referred to as emulsification if the resulting blend(s) is relatively homogeneous (e.g., well mixed). Additionally or alternatively, in some embodiments, one or more of the preliminary blend (e.g., after mixing at 104), the intermediate blend (e.g., after mixing of the thickening agent added at 106), and/or the primary blend (e.g., after processing at 108 and/or 110), can be an emulsion in a technical sense, which may depend on various factors, such as the ingredients used in preparation of the food product, a stability of the resulting blend, a phase of the various particles included in the blend, etc. For example, if one or more of the ingredients added at 104 acts as an emulsifying agent (e.g., one or more ingredients added at 104 can be an emulsifier), the preliminary blend resulting from mixing at 104 can be an emulsion. As another example, if one or more of the ingredients added at 104 and/or a thickening agent added at 106 acts as an emulsifying agent (e.g., is an emulsifier), the resulting intermediate blend can be an emulsion. As yet another example, if one or more of the ingredients added at 104 and/or a thickening agent added at 106 acts as an emulsifying agent (e.g., is an emulsifier), the primary blend resulting from processing mixing at 108 and/or 110 can be an emulsion.

At 112, process 100 can include packaging the whole-egg-based liquid in sealed containers. In some embodiments, process 100 can include adding and/or mixing non-liquid ingredients into the primary blend, such as fruit, nuts, herbs, etc.

In some embodiments, any suitable packaging technique(s) can be used to package the primary blend (including any added/mixed in non-liquid ingredients) in sealed components, such as conventional packaging processes.

At 114, process 100 can include pasteurizing the liquid food in the containers. In some embodiments, process 100 can include any suitable pasteurization process. For example, the filled and sealed containers can be submerged in liquid held at about 185° Fahrenheit until the internal temperature of the product reaches 165° Fahrenheit. The length of time that the filled container is submerged can vary based on various factors, such as a shape of the container. As another example, the filled and sealed containers can be placed into any suitable heat pasteurization device, such as a steam pasteurization device, and a heat pasteurization process can be carried out. As yet another example, the filled and sealed containers can be placed into any suitable high pressure processing (HPP) device, and an HPP process can be carried out. In some embodiments, pasteurizing the liquid food in the containers can extend a shelf-life of the product. In such an example, HPP can include applying a high pressure (e.g., in a range of about 58,000 pounds per square inch (psi) to about 87,000 psi) to the sealed containers, which can kill and/or deactivate food-borne pathogens, such as undesirable microorganisms, enzymes, and/or spores. As still another example, the filled and sealed containers can be placed into any suitable high-pressure-assisted thermal processing (HPTP) device, and an HPTP process can be carried out that includes using high-pressure to rapidly increase the internal temperature of the product from a relatively moderate temperature (e.g., in a range of about 140° to about 195° Fahrenheit) to a high temperature (e.g., in a range of about 195° to about 250° Fahrenheit). In some embodiments, pasteurizing the liquid food in the containers can extend a shelf-life of the product. Additionally or alternatively, in some embodiments, pasteurizing the liquid food can mitigate risks caused by food-borne pathogens that may have been introduced with one or more ingredients (e.g., by killing and/or deactivating undesirable microorganisms, enzymes, and/or spores that may be present in the liquid food prior to pasteurization).

After pasteurization at 114, the food in the containers can be ready for transportation and sale. Additionally, depending on a pasteurization process that is used, the food in the containers can be shelf stable for a relatively prolonged period of time (e.g., on the order of months sealed at room temperature), where the period of time can depend on various factors such as the final pH of the food as packaged. For example, pasteurizing using HPP techniques can result in a shorter refrigerated shelf life than can be obtained using some heat pasteurization techniques. The whole-egg-based liquid food packaged at 112 and pasteurized at 114 may or may not be an emulsion in a technical sense, which can depend, at least in part, on ingredients used in preparation of the food product. Additionally, the whole-egg-based liquid food packaged at 112 and pasteurized at 114 may or may not be a liquid in a technical sense, which can depend, at least in part, on ingredients used in preparation of the food product, how the ingredients are processed, an amount of time that passes after packaging of the food product, a temperature at which the packaged food product is stored, etc. For example, the whole-egg-based liquid food packaged at 112 and pasteurized at 114 may be a semisolid when stored, sold, and/or consumed. As another example, the whole-egg-based liquid food packaged at 112 and pasteurized at 114 may be a gel when stored, sold, and/or consumed.

In some embodiments, the food in the containers can be cooled to any suitable temperature. For example, if the product is a type of product that is generally sold refrigerated (e.g., yogurts, some types of smoothies, some types of dips, etc.), food in the containers can be cooled to refrigerator temperatures and distributed using a cold chain distribution process. As another example, if the product is a type of product that is generally sold at room temperature (e.g., many types of dressing, some types of smoothies, some types of dips, etc.), food in the containers can be cooled to room temperatures and distributed using distribution processes used to distribute such foods.

In some embodiments, one or more portions of process 100 can be carried out as a continuous production process. Additionally or alternatively, in some embodiments, one or more portions of process 100 can be carried out as a batch production process.

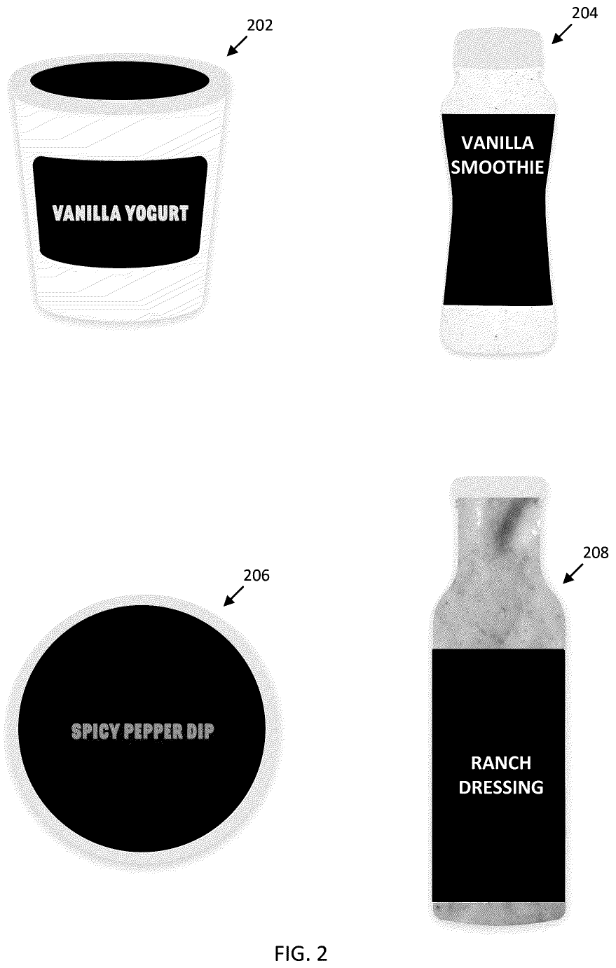

FIG. 2 shows examples of whole-egg-based liquid foods in accordance with some embodiments of the disclosed subject matter. In some embodiments, whole-egg-based liquid foods prepared as described herein can be packed in a variety of containers, having various shapes, sizes, closure mechanisms, etc., which can depend on the type of product, and how such a product is customarily packaged and/or used. For example, as shown in FIG. 2, a whole-egg-based non-dairy yogurt (e.g., a non-dairy vanilla yogurt) prepared using ingredients and techniques described herein can be packaged in a container 202 with a relatively wide opening that facilitates scooping of food from container 202. Container 202 can be sealed (e.g., using a plastic or foil seal), and can be distributed with a snap on lid that can be used to close the container after unsealing. Such a container can be described as a tube or cup. As another example, as shown in FIG. 2, a whole-egg-based non-dairy smoothie (e.g., a banana smoothie) prepared using ingredients and techniques described herein can be packaged in a container 204 with a relatively smaller opening, and screw-on lid, and a profile that facilitates pouring and/or drinking from container 204. Container 204 can be sealed by the screw-on lid, or can have an additional seal (e.g., using a plastic or foil seal). Such a container can be described as a bottle. As yet another example, as shown in FIG. 2, a whole-egg-based dip (e.g., a spicy pepper dip) prepared using ingredients and techniques described herein can be packaged in a container 206 with a relatively wide opening that facilitates scooping of food from container 206. Container 206 can be sealed (e.g., using a plastic or foil seal), and can be distributed with a snap on lid that can be used to close the container after unsealing. Such a container can be described as a tube or cup. As another example, as shown in FIG. 2, a whole-egg-based dressing (e.g., a spicy pepper dressing) prepared using ingredients and techniques described herein can be packaged in a container 208 with a relatively smaller opening, and screw-on lid, and a profile that facilitates pouring from container 208. Container 208 can be sealed by the screw-on lid, or can have an additional seal (e.g., using a plastic or foil seal). Such a container can be described as a bottle.

### EXAMPLES

### Example 1—Non-Dairy Vanilla Yogurt

In a first example, a whole-egg-based non-dairy vanilla yogurt can be prepared using techniques described herein. The example non-dairy vanilla yogurt includes whole-cooked eggs (including both cooked whites and cooked yolks in similar proportions to proportions found in whole eggs), coconut cream, water, banana puree, cane sugar, lemon juice, vanilla extract, lactic acid, guar gum, a probiotic, and lemon oil.

A particular example of the proportions of ingredients used to prepare a particular whole-egg-based non-dairy vanilla yogurt are included in TABLE 1. The combination of coconut cream, water, and banana puree contribute to a viscosity, texture, density, and mouth feel that is similar to dairy yogurt after setting. The yogurt produced in accordance with this example, using the ingredients in TABLE 1, had a consistency similar to Greek-style yogurt (e.g., Greek yogurt sold under the brand name CHOBANI). Non-dairy yogurts and products having a consistency similar to yogurt can be produced using techniques described herein that have a similar consistency as various different varieties of yogurt and/or custard, such as Icelandic-style yogurt (e.g., skyr sold under the brand name ICELANDIC PROVISIONS), American-style yogurt, etc. The banana puree and cane sugar provide sweetness, and the lemon juice and vanilla extract contribute to flavor. The lactic acid and lemon juice lower the pH to a target range of about 3.9 to 4.4. The guar gum is a thickening agent (e.g., added at 106), and can contribute to a viscosity, texture, density, and mouth feel that is similar to dairy-based yogurt. The lemon oil can impact the taste of the non-dairy vanilla yogurt, as it can mitigate the taste of sulfur compounds included in the whole eggs.

TABLE 1

| Ingredient | % by weight |
|---|---|
| Whole Hard Cooked Egg | 51.7 |
| Coconut Cream | 22.8 |
| Water | 15.0 |
| Banana Puree | 4.5 |
| Cane Sugar | 2.4 |
| Lemon Juice | 1.8 |
| Vanilla Extract | 0.9 |
| Lactic Acid | ~0.7 |
| Guar Gum | ~0.2 |
| BC30 Probiotic | <0.1 |
| Lemon Oil | <0.001 |

The whole hard cooked eggs, coconut cream, water, banana puree, cane sugar, lemon juice, vanilla extract, lactic acid, BC30, and lemon oil were blended together until the combination was liquified. The guar gum was added to the liquified mixture, and the resulting mixture was blended for an additional five minutes, and then processed through a COMITROL Processor Model 1500 with a microcut head. After processing through the COMITROL Processor Model 1500, 150 grams (g) of the liquid whole-egg-based non-dairy vanilla yogurt was packaged into individual cups (e.g., similar to container 202), which were then sealed. The sealed cups were submerged in 185° water until the minimum internal temperature reached 165° (about 26 minutes), and the sealed cups were then cooled to room temperature. The sealed and heat pasteurized cups of whole-egg-based non-dairy vanilla yogurt sets to a semisolid consistency in the sealed cups, and is ready to eat after cooling to an appropriate and/or desired temperature.

### Example 2—Non-Dairy Banana Smoothie

In a second example, a whole-egg-based non-dairy vanilla smoothie can be prepared using techniques described herein. The example non-dairy vanilla smoothie includes whole-cooked eggs (including both cooked whites and cooked yolks in similar proportions to proportions found in whole eggs), coconut cream, water, banana puree, cane sugar, pureed sweet corn, lemon juice, vanilla extract, lactic acid, guar gum, vanilla powder, and a probiotic, and lemon oil.

The ingredients used to prepare a particular whole-egg-based non-dairy vanilla smoothie included similar ingredients to the vanilla yogurt of Example 1, but had a higher proportion of water, and addition of pureed sweet corn and vanilla powder. The combination of coconut cream, water, and banana puree contribute to a density, texture, and mouth feel that is similar to dairy-based smoothie drinks (e.g., yogurt-based smoothies). The banana puree, cane sugar, and pureed sweet corn provide sweetness (and contribute to flavor), and the lemon juice, vanilla extract, and vanilla powder contribute to flavor. The lactic acid and lemon juice lower the pH to a target range of about 3.9 to 4.4. The guar gum is a thickening agent (e.g., added at 106), and can contribute to a density, texture, and mouth feel that is similar to a dairy-based smoothie drink. The lemon oil can impact the taste of the non-dairy banana smoothie, as it can mitigate the taste of sulfur compounds included in the whole eggs.

The whole hard cooked eggs, coconut cream, water, banana puree, sugar, pureed sweet corn, lemon juice, vanilla extract, lactic acid, vanilla powder, and BC30 were blended together until the combination was liquified. The guar gum was added to the liquified mixture, and the resulting mixture was blended for an additional five minutes, and then processed through a COMITROL Processor Model 1500 with a microcut head. After processing through the COMITROL Processor Model 1500, 240 milliliters (ml) of the liquid whole-egg-based non-dairy smoothie was packaged into individual bottles (e.g., similar to container 204), which were then sealed. The sealed bottles were submerged in 185° water until the minimum internal temperature reached 165°, and the sealed bottles were then cooled to room temperature. The sealed and heat pasteurized bottles of whole-egg-based non-dairy banana smoothie are ready to consume (e.g., drink) after cooling to an appropriate and/or desired temperature.

### Example 3—Protein Rich, Dairy Free, Spicy Pepper Dip

In a third example, a whole-egg-based spicy pepper dip can be prepared using techniques described herein. The example spicy pepper dip includes whole-cooked eggs (including both cooked whites and cooked yolks in similar proportions to proportions found in whole eggs), roasted red pepper, mango, sweet potato puree, lime juice, sugar, lactic acid, sea salt, spices, guar gum, yeast extract, and lime oil.

The ingredients used to prepare a particular whole-egg-based spicy pepper dip included cooked whole eggs and roasted red pepper as main ingredients (about 50% by weight whole eggs), and the other ingredients each made up less than 20% by weight of the whole-egg-based spicy pepper dip. The combination of cooked whole eggs, roasted red pepper, mango, and sweet potato puree contribute to a density, texture, and mouth feel that is similar to hummus. The roasted red pepper, mango, sweet potato puree, lime juice, sea salt, spices, and yeast extract, contribute to flavor. The lactic acid and lime juice lower the pH to a target range of about 3.9 to 4.4. The guar gum is a thickening agent (e.g., added at 106), and can contribute to a density, texture, and mouth feel that is similar to a hummus. The lime oil can impact the taste of the non-dairy banana smoothie, as it can mitigate the taste of sulfur compounds included in the whole eggs.

The whole hard cooked eggs, roasted red pepper, mango, sweet potato puree, lime juice, sugar, lactic acid, sea salt, spices, yeast extract, and lime oil were blended together until the combination was liquified. The guar gum was added to the liquified mixture, and the resulting mixture was blended for an additional five minutes, and then processed through a COMITROL Processor Model 1500 with a microcut head. After processing through the COMITROL Processor Model 1500, about 280 grams (g) of the liquid whole-egg-based spicy pepper dip was packaged into individual tubs (e.g., similar to container 206), which were then sealed. The sealed tubs were submerged in 185° water until the minimum internal temperature reached 165°, and the sealed tubs were then cooled to room temperature. The sealed and heat pasteurized tubs of whole-egg-based dips are ready to eat after cooling to an appropriate and/or desired temperature.

### Example 4—Protein Rich, Dairy Free, Ranch Dressing

In a fourth example, a whole-egg-based ranch dressing can be prepared using techniques described herein. The example ranch dressing includes whole-cooked eggs (including both cooked whites and cooked yolks in similar proportions to proportions found in whole eggs), water, spices, lemon juice, lactic acid, guar gum, and lemon oil.

The ingredients used to prepare a particular whole-egg-based ranch dressing included cooked whole eggs and water as main ingredients (about 50% by weight whole eggs), and the other ingredients made up less than 5% by weight of the whole-egg-based ranch dressing. The combination of cooked whole eggs and water contribute to a density, texture, and mouth feel that is similar to a ranch salad dressing. The spices contribute to flavor. The lactic acid and lemon juice lower the pH to a target range of about 3.9 to 4.4. The guar gum is a thickening agent (e.g., added at 106), and can contribute to a density, texture, and mouth feel that is similar to a ranch dressing. The lemon oil can impact the taste of the non-dairy banana smoothie, as it can mitigate the taste of sulfur compounds included in the whole eggs.

The whole hard cooked eggs, water, spices, lemon juice, and lactic acid were blended together until the combination was liquified. The guar gum was added to the liquified mixture, and the resulting mixture was blended for an additional five minutes, and then processed through a COMITROL Processor Model 1500 with a microcut head. After processing through the COMITROL Processor Model 1500, about 355 milliliters (ml) of the liquid whole-egg-based ranch dressing was packaged into individual bottles (e.g., similar to container 208), which were then sealed. The sealed bottles were submerged in 185° water until the minimum internal temperature reached 165°, and the sealed bottles were then cooled to room temperature. The sealed and heat pasteurized bottles of whole-egg-based dressing is ready to consume after cooling to an appropriate and/or desired temperature.

### Further Examples Having a Variety of Features

Implementation examples are described in the following numbered clauses:
1. A non-dairy hard cooked egg-based liquid food product, comprising: a predetermined amount of liquified hard-cooked egg, the hard-cooked egg including cooked egg yolk and cooked egg white, wherein the predetermined amount of hard-cooked egg is at least about 33% by weight of the non-dairy egg-based liquid food product; a predetermined amount of liquid having a moisture content of at least about 65% by weight, wherein the predetermined amount of liquid is at least about 15% by weight of the non-dairy egg-based liquid food product; one or more flavoring ingredients; an acidifier; a thickening agent; and a predetermined amount of a food additive for mitigating an impact of sulfurous compounds on a taste of the non-dairy egg-based liquid food product, wherein the predetermined amount of the food additive is less than 0.01% by weight of the non-dairy egg-based liquid food product; and wherein the non-dairy egg-based liquid food product has a pH between about 3.9 to about 4.4.
2. A non-dairy hard cooked egg-based liquid food product, comprising: a predetermined amount of liquified hard-cooked egg, the hard-cooked egg including cooked egg yolk and cooked egg white, wherein the predetermined amount of hard-cooked egg is at least about 33% by weight of the non-dairy egg-based liquid food product; a predetermined amount of liquid having a moisture content of at least about 65% by weight, wherein the predetermined amount of liquid is at least about 15% by weight of the non-dairy egg-based liquid food product; one or more flavoring ingredients; an acidifier; a thickening agent; and a predetermined amount of oil comprising citral, wherein the predetermined amount of oil comprising citral is less than 0.01% by weight of the non-dairy egg-based liquid food product; and wherein the non-dairy egg-based liquid food product has a pH between about 3.9 to about 4.4.
3. The non-dairy egg-based liquid food product of any one of clauses 1 or 2, wherein the non-dairy egg-based liquid food product is a semi-solid non-dairy yogurt.
4. The non-dairy egg-based liquid food product of clause 3, wherein the flavoring ingredients comprise vanilla extract, wherein the predetermined amount of liquid comprises: coconut cream; water; banana puree; and lemon juice, and wherein the non-dairy egg-based liquid food product comprises a spore-form probiotic.
5. The non-dairy egg-based liquid food product of any one of clauses 1 or 2, wherein the non-dairy egg-based liquid food product is a non-dairy drink.
6. The non-dairy egg-based liquid food product of clause 5, wherein the flavoring ingredients comprise vanilla extract and vanilla powder, and wherein the predetermined amount of liquid comprises: coconut cream; water; banana puree; and lemon juice.
7. The non-dairy egg-based liquid food product of any one of clauses 1 or 2, wherein the non-dairy egg-based liquid food product is a dip.
8. The non-dairy egg-based liquid food product of clause 7, wherein the flavoring ingredients comprise roasted red pepper mango, sea salt, and spices, and wherein the predetermined amount of liquid comprises: water; sweet potato puree; and lime juice.
9. The non-dairy egg-based liquid food product of any one of clauses 1 or 2, wherein the non-dairy egg-based liquid food product is a salad dressing.
10. The non-dairy egg-based liquid food of clause 9, wherein the flavoring ingredients comprise spices, and wherein the predetermined amount of liquid comprises: water; and lemon juice.
11. The non-dairy egg-based liquid food product of any one of claims 1 to 10, wherein a ratio of cooked egg yolk to cooked egg white is about 2:1 by weight.
12. The non-dairy egg-based liquid food product of any one of claims 1 to 11, wherein the predetermined amount of hard-cooked egg is at least about 50% by weight of the non-dairy egg-based liquid food product.
13. The non-dairy egg-based liquid food product of any one of claim 1 to 6, or 9-12, wherein the predetermined amount of liquid comprises water that is at least about 15% by weight of the non-dairy egg-based liquid food product.
14. The non-dairy egg-based liquid food product of any one of claims 2-13 wherein the predetermined amount of the food additive includes an oil comprising citral.
15. The non-dairy egg-based liquid food product of any one of clauses 1 to 14, wherein the predetermined amount of oil comprising citral includes lemon oil with a citral content of about 2% to about 5% by weight of the lemon oil, or lime oil with a citral content of about 2% to about 5% by weight of the lime oil.
16. The non-dairy egg-based liquid food product of any one of clauses 1 to 15, wherein the thickening agent comprises guar gum.
17. The non-dairy egg-based liquid food product of any one of clauses 1 to 16, wherein the acidifier comprises lactic acid.
18. The non-dairy egg-based liquid food product of clause 17, wherein the acidifier further comprises lemon juice or lime juice.
19. The non-dairy egg-based liquid food product of any one of clauses 1 to 18, wherein the non-dairy egg-based liquid food product does not include any purified fat ingredients, other than the predetermined amount of oil comprising citral.
20. The non-dairy egg-based liquid food product of any one of clauses 1 to 19, wherein the non-dairy egg-based liquid food product does not include any of the following ingredients in an amount greater than 0.01% by weight of the non-dairy egg-based liquid food product: olive oil; canola oil; and mayonnaise.
21. The non-dairy egg-based liquid food product of any one of clauses 1 to 20, wherein the non-dairy egg-based liquid food product is at least 6% protein by weight.
22. A method of making a non-dairy egg-based liquid food product, the method comprising: mixing a predetermined amount of hard-cooked egg, a predetermined amount of liquid having a moisture content of at least about 65% by weight, one or more flavoring ingredients, an acidifier, and a predetermined amount of oil comprising citral, thereby forming a preliminary blend comprising the predetermined amount of hard-cooked egg, the predetermined amount of liquid, the one or more flavoring ingredients, the acidifier, and the predetermined amount of oil comprising citral; mixing a thickening agent into the preliminary blend, thereby forming an intermediate blend from the preliminary blend and the thickening agent; homogenizing the intermediate blend, thereby forming a primary blend from the intermediate blend, wherein the primary blend has a pH between about 3.9 to about 4.4; adding the non-dairy egg-based liquid food comprising the primary blend to a plurality of containers; sealing the plurality of containers; pasteurizing the non-dairy egg-based liquid food in the plurality of sealed containers, wherein the internal temperature of the non-dairy egg-based liquid food reaches a safety threshold temperature during pasteurization; and cooling the non-dairy egg-based liquid food after pasteurization.
23. The method of clause 22, wherein the safety threshold temperature is about 165° Fahrenheit.
24. The method of any one of clauses 22 or 23, wherein the non-dairy egg-based liquid food is the non-dairy egg-based liquid food of any one of clauses 1-21.
25. The method of any one of clauses 22 to 24, wherein pasteurizing the non-dairy egg-based liquid food in the plurality of sealed containers comprises: applying high pressure to the plurality of sealed containers to mitigate risks caused by food-borne pathogens.

It should be understood that above-described steps of the processes of FIG. 1 can be executed or performed in any suitable order or sequence not limited to the order and sequence shown and described in the figures. Also, some of the above steps of the processes of FIG. 1 can be executed or performed substantially simultaneously where appropriate or in parallel to reduce latency and processing times.

This written description uses examples to disclose the invention(s), including the best mode, and also to enable any person skilled in the art to make and use the invention(s). Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention(s) is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A non-dairy hard cooked egg-based liquid food product, comprising:
a predetermined amount of liquified hard-cooked egg, the hard-cooked egg including cooked egg yolk and cooked egg white,
wherein the predetermined amount of hard-cooked egg is at least about 33% by weight of the non-dairy egg-based liquid food product;
a predetermined amount of liquid having a moisture content of at least about 65% by weight,
wherein the predetermined amount of liquid is at least about 15% by weight of the non-dairy egg-based liquid food product;
one or more flavoring ingredients;
an acidifier;
a thickening agent; and
a predetermined amount of a food additive for mitigating an impact of sulfurous compounds on a taste of the non-dairy egg-based liquid food product,
wherein the predetermined amount of the food additive is less than 0.01% by weight of the non-dairy egg-based liquid food product; and
wherein the non-dairy egg-based liquid food product has a pH between about 3.9 to about 4.4.

2. The non-dairy egg-based liquid food product of claim 1, wherein the non-dairy egg-based liquid food product is a semisolid non-dairy yogurt, a non-dairy drink, a dip, or a salad dressing.

3. The non-dairy egg-based liquid food product of claim 2, wherein the non-dairy egg-based liquid food product is the semisolid non-dairy yogurt,
wherein the flavoring ingredients comprise vanilla extract,
wherein the predetermined amount of liquid comprises:
coconut cream;
water;
banana puree; and
lemon juice, and
wherein the non-dairy egg-based liquid food product comprises a spore-form probiotic.

4. The non-dairy egg-based liquid food product of claim 2, wherein the non-dairy egg-based liquid food product is the non-dairy drink,
wherein the flavoring ingredients comprise vanilla extract and vanilla powder, and
wherein the predetermined amount of liquid comprises:
coconut cream;
water;
banana puree; and
lemon juice.

5. The non-dairy egg-based liquid food product of claim 2, wherein the non-dairy egg-based liquid food product is the dip,
wherein the flavoring ingredients comprise roasted red pepper, mango, sea salt, and spices, and
wherein the predetermined amount of liquid comprises:
water;
sweet potato puree; and
lime juice.

6. The non-dairy egg-based liquid food product of claim 2, wherein the non-dairy egg-based liquid food product is the salad dressing,
wherein the flavoring ingredients comprise spices, and
wherein the predetermined amount of liquid comprises:
water; and
lemon juice.

7. The non-dairy egg-based liquid food product of claim 1, wherein a ratio of cooked egg yolk to cooked egg white is about 2:1 by weight.

8. The non-dairy egg-based liquid food product of claim 1, wherein the predetermined amount of hard-cooked egg is at least about 50% by weight of the non-dairy egg-based liquid food product.

9. The non-dairy egg-based liquid food product of claim 1, wherein the predetermined amount of liquid comprises water that is at least about 15% by weight of the non-dairy egg-based liquid food product.

10. The non-dairy egg-based liquid food product of claim 1, wherein the predetermined amount of the food additive includes an oil comprising citral,

11. The non-dairy egg-based liquid food product of claim 10, wherein the oil comprising citral includes lemon oil with a citral content of about 2% to about 5% by weight of the lemon oil.

12. The non-dairy egg-based liquid food product of claim 1, wherein the thickening agent comprises guar gum.

13. The non-dairy egg-based liquid food product of claim 1, wherein the acidifier comprises lemon juice or lime juice.

14. The non-dairy egg-based liquid food product of claim 1, wherein the non-dairy egg-based liquid food product does not include any purified fat ingredients in an amount greater than 0.01% by.

15. The non-dairy egg-based liquid food product of claim 14, wherein the non-dairy egg-based liquid food product does not include any of the following ingredients in an amount greater than 0.01% by weight of the non-dairy egg-based liquid food product:
olive oil;
canola oil; and
mayonnaise.

16. The non-dairy egg-based liquid food product of claim 1, wherein the non-dairy egg-based liquid food product is at least 6% protein by weight.

17. A method of making a non-dairy egg-based liquid food product, the method comprising:
mixing
a predetermined amount of hard-cooked egg,
a predetermined amount of liquid having a moisture content of at least about 65% by weight,
one or more flavoring ingredients,
an acidifier, and
a predetermined amount of a food additive for mitigating an impact of sulfurous compounds on a taste of the non-dairy egg-based liquid food product,
thereby forming a preliminary blend comprising the predetermined amount of hard-cooked egg, the predetermined amount of liquid, the one or more flavoring ingredients, the acidifier, and the predetermined amount of the food additive;
mixing a thickening agent into the preliminary blend, thereby forming an intermediate blend from the preliminary blend and the thickening agent;
homogenizing the intermediate blend, thereby forming a primary blend from the intermediate blend,
wherein the primary blend has a pH between about 3.9 to about 4.4;
adding the non-dairy egg-based liquid food comprising the primary blend to a plurality of containers;
sealing the plurality of containers;
pasteurizing the non-dairy egg-based liquid food in the plurality of sealed containers,
wherein the internal temperature of the non-dairy egg-based liquid food reaches a safety threshold temperature during pasteurization; and
cooling the non-dairy egg-based liquid food after pasteurization.

18. The method of claim 17, wherein the safety threshold temperature is about 165° Fahrenheit.

19. The method of claim 17, wherein the non-dairy egg-based liquid food is a semisolid non-dairy yogurt, a non-dairy drink, a dip, or a salad dressing.

20. The method of claim 17, wherein pasteurizing the non-dairy egg-based liquid food in the plurality of sealed containers comprises:
applying high pressure to the plurality of sealed containers to mitigate risks caused by food-borne pathogens.
